(19) United States
(12) Patent Application Publication
(10) Pub. No.: US 2010/0320796 A1
(43) Pub. Date: Dec. 23, 2010

(54) Device on a vehicle a pillar

(76) Inventors: Patrick Hoefer, Gaertringen (DE); Teddy Woll, Leonberg (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/631,817

(22) PCT Filed: Jun. 23, 2005
(86) PCT No.: PCT/EP05/06789

§ 371 Date: Oct. 2, 2008

(30) Foreign Application Priority Data
Jul. 7, 2004 (DE) 10 2004 032 726.2

(51) Int. Cl. B60J 10/02

(52) U.S. Cl. 296/93

(57) ABSTRACT

In order to provide a device on a vehicle A pillar, level with the windshield, for keeping an adjacent side region of the vehicle free from dirty water deflected by the windshield, with a guide element which can be displaced between a rest position and an active position and, in its active position, removes dirty water deflected laterally by the windshield outward to the adjacent side of the vehicle, which device meets the aeroacoustic requirements and the requirements for keeping the vehicle free from dirt, it is proposed to provide a plurality of active positions for the guide element.

### CROSS REFERENCE TO RELATED APPLICATIONS

This application is a National Stage of PCT International Application No. PCT/EP2005/006789, filed Jun. 23, 2005, which claims priority under 35 U.S.C. §119 to German Patent Application No. 10 2004 032 726.2, filed Jul. 7, 2004, the entire disclosures of which are herein expressly incorporated by reference.

### BACKGROUND AND SUMMARY OF THE INVENTION

The present invention relates to a device on a vehicle A pillar, level with the windshield, for keeping an adjacent side region of the vehicle free from dirty water deflected by the windshield.

Such devices are generally known from the prior art. For example, German patent document DE 39 36 372 A1 discloses a passenger vehicle with a windshield and a profiled rail, which is arranged on a vehicle A pillar level with the windshield and can be transferred via a servomotor from an inoperative position into an active position. The profiled rail serves to conduct away water, which acts upon the windshield, in a specific manner. German patent document DE 31 19 358 C2 discloses a corresponding device, in which the servomotor is activated as a function of the position of a windshield wiper switch or of a moisture sensor. In German patent document DE 100 29 294 C1, the servomotor is activated via signals from a rain sensor, a movement rotor of a windshield wiper or a temperature sensor detecting the ambient temperature. A common feature of the known devices is that in each case only a rest position and an active position are provided for the profiled rail.

An object of the present invention is to provide a device of the generic type described above, which satisfies the aeroacoustic requirements and the requirements for keeping motor vehicles free from dirt.

This and other objects and advantages are achieved by the device according to the present invention, which provides a guide element that is arranged in a side region of a vehicle adjacent to a windshield, and laterally removes dirty water deflected by the windshield. The guide element is configured such that it can be displaced from a rest position into a plurality of different active positions, with the transition from one active position into another active position being continuous (i.e., stepless). However, according to another embodiment, the active positions can differ so greatly from one another that an adjustment from one active position into another active position takes place via a step. The number of active positions can be selected as a function of the specific application. In the case of a continuous transition from one active position into another, an infinite number of active positions are conceivable.

The invention affords the advantage that the guide element can be set as a function of need. One of the active positions can be selected depending in each case on how much water strikes against the windshield and has to be removed. In this manner, the optimum active position, with regard to the quantity of water to be removed, and also with regard to the noises produced by the guide element, can be set in each case.

The active positions can differ, for example, in the deployment height (that is the extent of displacement from the A pillar) of the guide element, which is therefore extended to a different extent depending on which active position it takes up. However, the active positions may also differ through other features, such as the positioning angle of the guide element relative to the windshield. For example, the aeroacoustically lowest-noise position of the guide element can be set in each case in accordance with the motto: “as high as necessary, as low as possible”, so that the guide element is completely extended only when there is very heavy rain.

The active positions of the guide element can be set, for example, as a function of the quantity of water striking against the windshield. In other words, the guide element is provided with a control as a function of need, which functions, for example in such a manner that the guide element is extended further the more water there is on the windshield which has to be removed.

In order to set the particular active position, a control unit can be provided which acts on a servomotor that transfers the guide element from the rest position into its active position. The control unit may be fed with data from the rain sensor. The rain sensor supplies information about the quantity of water on the windshield, so that the data from the rain sensor can be used to set the guide element as a function of the quantity of water striking against the windshield. Also, data on the wiper frequency selected by the driver may be supplied to the control unit. The wiper frequency can be an indication of the quantity of water on the windshield. Every other influencing variable which provides a conclusion about the quantity of water on the windshield may be used for the control.

According to an exemplary embodiment of the present invention, the guide element may be transferred into its active position even before a first wiping cycle of the windshield wipers. This affords the advantage that the water striking against the windshield can be optimally removed from the first instant. The feature, according to which the guide element is transferred into its rest position only after the last wiping cycle, provides a corresponding advantage. This can also be controlled, for example, via the rain sensor.

According to another exemplary embodiment of the present invention, the guide element may be transferred into its active position when the wash and wipe operation is activated. The wash and wipe operation of the windows—actuation of the windshield wipers with additional wiping water for cleaning the windows—also has to be taken into consideration in the control of the guide element. In this case a spraying delay of the washing water may be provided, so that the latter only strikes against the window when the guide element has taken up its active position.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a perspective plan view of the left A pillar of a vehicle,

FIGS. 2a-2c show a section through the A pillar according to line II-II in FIG. 1, and

FIG. 3 shows a schematic overview of the circuit.

### DETAILED DESCRIPTION OF THE DRAWINGS

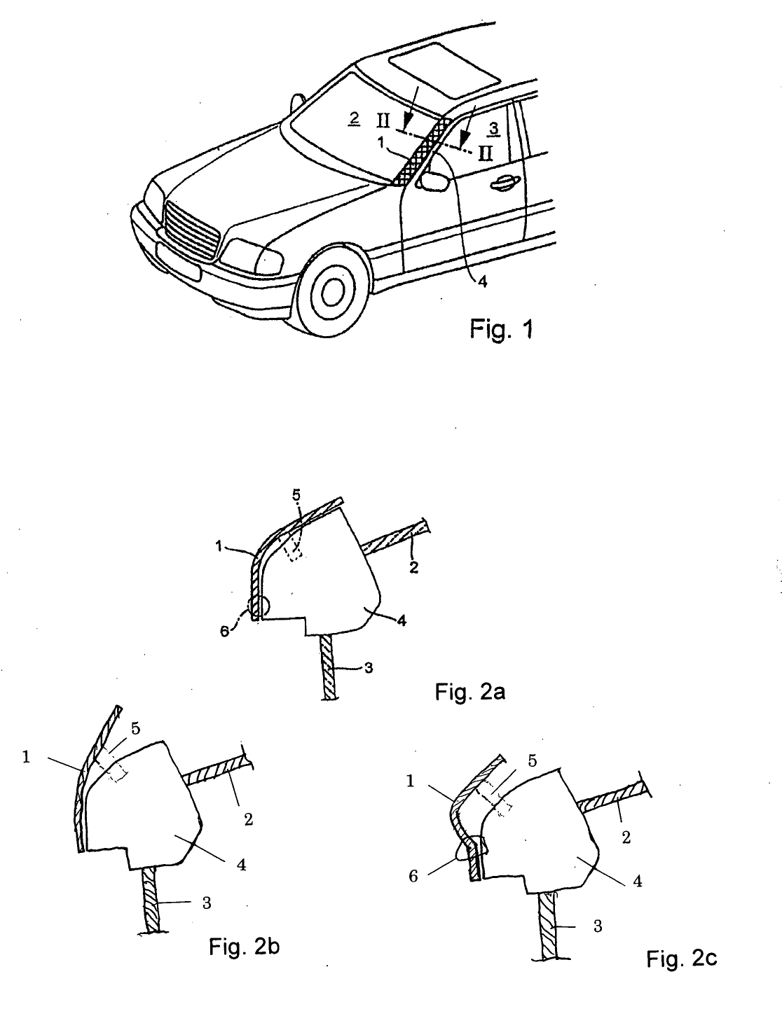

Referring to FIG. 1, the windshield of a vehicle is denoted by the reference numeral 2 and the side window adjacent on the left to the A pillar is denoted by the reference numeral 3. The front region of the A pillar 4 of the vehicle is completely covered over its entire height by a covering designed as a displaceable guide element 1. The guide element 1, which can serve as an all-over, front A pillar covering, is formed from elastic, high-strength material, such as plastic. In order to move the guide element 1 between the rest position (FIG. 2a) and an active position (FIGS. 2b and 2c), in which dirty water can be collected from the windshield 2 to the side of the vehicle and conducted away upwards or downwards along the guide element 1, an actuator 5 connected to the guide element 1 is provided in the A pillar 4.

It is possible to adjust the guide element 1 exclusively by individual actuators 5 fitted in each case at different heights of the A pillar 4 (FIG. 2b). However, it is possible to allow these actuators 5 to interact with joints provided between the A pillar 4 and the guide element 1 (FIG. 2c). A corresponding joint 6 is indicated schematically on the side of the vehicle in FIGS. 2a and 2c.

The actuators 5 can also interact with springs provided between the guide element 1 and the A pillar 4. In a rest position of the guide element 1, the springs advantageously have potential spring tension energy which can be released in order to open the flow channel.

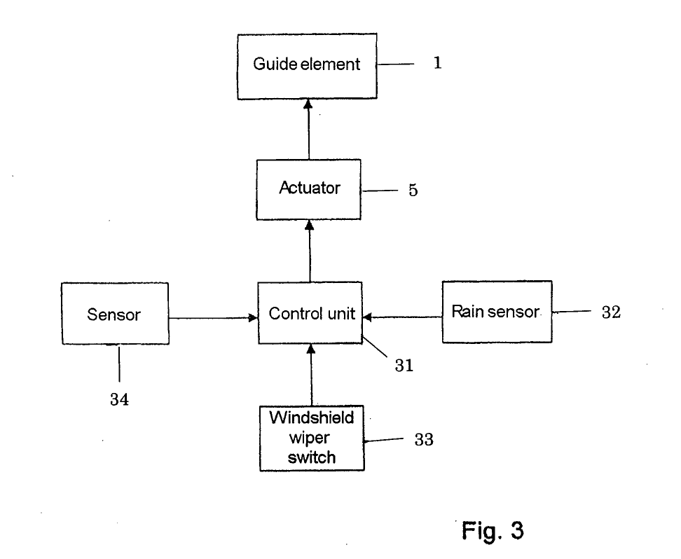

FIG. 3 illustrates a possible control circuit for the device depicted in FIGS. 1 and 2a-2c. A control unit 31 is provided acts on the actuator or actuators 5 which in turn transfer the guide element 1 from a rest position into an active position. The control unit receives signals from a rain sensor 32, so that the control unit passes on signals to the actuator or actuators 5 such that the guide element 1 is raised further as more rain strikes against the windshield 2. However, the control unit 31 can also receive signals from a windshield wiper switch 33. The higher the setting of the windshield wiper frequency, the greater is the quantity of rainwater striking against the windshield and the higher the guide element is to be set. However, the control unit can also operate as a function of other sensors 34 which provide information about the quantity of water striking against the windshield 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A device on a vehicle A pillar, which is level with a windshield of a vehicle, for keeping an adjacent side region of the vehicle free from water deflected by the windshield, comprising:
a guide element which is displaceable between a rest position and a plurality of active positions and, in the active positions, guides water deflected laterally by the windshield, upward or downward, to an adjacent side of the vehicle.

12. The device on a vehicle A pillar as claimed in claim 11, wherein the active positions differ in deployment height of the guide element.

13. The device on a vehicle A pillar as claimed in claim 11, wherein the active positions of the guide element are set as a function of the quantity of water striking against the windshield.

14. The device on a vehicle A pillar as claimed in claim 11, further comprising a control unit configured to set the active positions.

15. The device on a vehicle A pillar as claimed in claim 14, wherein the control unit receives data from the rain sensor.

16. The device on a vehicle A pillar as claimed in claim 14, wherein the control unit receives data on windshield wiper frequency selected by a driver.

17. The device on a vehicle A pillar as claimed in claim 11, wherein the guide element is transferred into at least one of the active positions before a first wiping cycle of windshield wipers.

18. The device on a vehicle A pillar as claimed in claim 11, wherein the guide element is transferred into the rest position after the last wiping cycle of windshield wipers.

19. The device on a vehicle A pillar as claimed in claim 11, wherein the guide element is transferred into at least one of the active positions during a wash and wipe operation.

20. The device on a vehicle A pillar as claimed in claim 19, wherein a spraying delay is provided during the wash and wipe operation.

21. The device on a vehicle A pillar as claimed in claim 12, wherein the active positions of the guide element are set as a function of the quantity of water striking against the windshield.

22. The device on a vehicle A pillar as claimed in claim 12, further comprising a control unit configured to set the active positions.

23. The device on a vehicle A pillar as claimed in claim 13, further comprising a control unit configured to set the active positions.

24. The device on a vehicle A pillar as claimed in claim 12, wherein the guide element is transferred into at least one of the active positions before a first wiping cycle of windshield wipers.

25. The device on a vehicle A pillar as claimed in claim 13, wherein the guide element is transferred into at least one of the active positions before a first wiping cycle of windshield wipers.

26. The device on a vehicle A pillar as claimed in claim 12, wherein the guide element is transferred into the rest position after the last wiping cycle of windshield wipers.

27. The device on a vehicle A pillar as claimed in claim 13, wherein the guide element is transferred into the rest position after the last wiping cycle of windshield wipers.

28. The device on a vehicle A pillar as claimed in claim 12, wherein the guide element is transferred into at least one of the active positions during a wash and wipe operation.

29. The device on a vehicle A pillar as claimed in claim 13, wherein the guide element is transferred into at least one of the active positions during a wash and wipe operation.

30. The device on a vehicle A pillar as claimed in claim 28, wherein a spraying delay is provided during the wash and wipe operation.
